(19) United States
(12) Patent Application Publication
(10) Pub. No.: US 2026/0154969 A1
(43) Pub. Date: Jun. 4, 2026

(54) ELECTRONIC APPARATUS AND CONTROL METHOD THEREOF

(71) Applicant: SAMSUNG ELECTRONICS CO., LTD., Suwon-si (KR)

(72) Inventors: Seongmin KANG, Suwon-si (KR); Heungwoo Han, Suwon-si (KR); Boseok Moon, Suwon-si (KR)

(73) Assignee: SAMSUNG ELECTRONICS CO., LTD., Suwon-si (KR)

(21) Appl. No.: 19/409,095

(22) Filed: Dec. 4, 2025

Related U.S. Application Data
(63) Continuation of application No. PCT/KR2025/018609, filed on Nov. 12, 2025.

(30) Foreign Application Priority Data
Dec. 4, 2024 (KR) 10-2024-0178464

(51) Int. Cl. G06V 20/56; A47L 11/40; G05D 1/648; G05D 105/10; G06V 10/74; G06V 10/82

(52) U.S. Cl. CPC G06V 20/56; A47L 11/4011; G05D 1/6486; G06V 10/74; G06V 10/82; G05D 2105/10

(57) ABSTRACT

An electronic apparatus includes a camera sensor, at least one processor, and memory storing instructions that, when executed by the at least one processor individually or collectively, cause the electronic apparatus to acquire information on stains in a travel space by inputting, to a trained first neural network model, a first image acquired through the camera sensor while the electronic apparatus travels the travel space in a first cleaning mode, based on identifying stains in a first area of the travel space based on the information, perform cleaning of the first area by changing the first cleaning mode to a second cleaning mode, based on completing the cleaning of the first area, acquire a second image of the first area through the camera sensor, and identify whether the stains are removed, by inputting, to a trained second neural network model, the first image and the second image.

### CROSS REFERENCE TO RELATED APPLICATIONS

This application is a by-pass continuation of an International Application No. PCT/KR2025/018609, filed on Nov. 12, 2025, which is based on and claims priority to Korean Patent Application No. 10-2024-0178464, filed on Dec. 4, 2024, in the Korean Intellectual Property Office, the disclosures of which are incorporated by reference herein in their entireties.

### BACKGROUND

### 1. Field

This disclosure relates to an electronic apparatus and a control method thereof, and particularly, to an electronic apparatus having a cleaning mode related to cleaning a space, and a control method thereof.

### 2. Description of Related Art

With the advancement in electronic technologies, various types of electronic apparatuses have been developed and provided, and in recent years, technology development in the area of robots providing services to users and the like has advanced. In the case of a robot traveling a specific space to provide a service to a user, the robot may consider the context (e.g., the type of an object present in a travel space) of a travel path while traveling.

### SUMMARY

According to an aspect of the disclosure, an electronic apparatus includes: a camera sensor; memory storing instructions; and at least one processor including processing circuitry, and wherein the instructions, when executed by the at least one processor individually or collectively, cause the electronic apparatus to: acquire information on one or more stains in a travel space by inputting, to a trained first neural network model, a first image acquired through the camera sensor, wherein the first image is acquired while the electronic apparatus travels in the travel space in a first cleaning mode; based on identifying a stain in a first area of the travel space, among the one or more stains, based on the acquired information, perform cleaning of the first area by changing the first cleaning mode to a second cleaning mode; based on completion of the performing the cleaning of the first area, acquire a second image of the first area through the camera sensor; and identify whether the stain is removed by inputting, to a trained second neural network model, the acquired first image and the acquired second image.

According to an aspect of the disclosure method of operating an electronic apparatus, includes: acquiring information on one or more stains in a travel space by inputting, to a trained first neural network model, a first image acquired through a camera sensor of the electronic apparatus, wherein the first image is acquired while the electronic apparatus travels in the travel space in a first cleaning mode; based on identifying a stain in a first area of the travel space, among the one or more stains, based on the acquired information, performing cleaning of the first area by changing the first cleaning mode to a second cleaning mode; based on completion of the performing the cleaning of the first area, acquiring a second image of the first area through the camera sensor; and identifying whether the stain is removed by inputting, to a trained second neural network model, the acquired first image and the acquired second image.

According to an aspect of the disclosure, a non-transitory computer readable storage medium has instructions stored therein, which when executed by at least one processor of an electronic apparatus individually or collectively, cause the electronic apparatus to: acquire information on one or more stains in a travel space by inputting, to a trained first neural network model, a first image acquired through a camera sensor of the electronic apparatus, wherein the first image is acquired while the electronic apparatus travels in the travel space in a first cleaning mode; based on identifying a stain in a first area of the travel space, among the one or more stains, based on the acquired information, perform cleaning of the first area by changing the first cleaning mode to a second cleaning mode; based on completing the cleaning of the first area, acquire a second image of the first area through the camera sensor; and identify whether the stain is removed by inputting, to a trained second neural network model, the acquired first image and the acquired second image.

### BRIEF DESCRIPTION OF THE DRAWINGS

The above and other aspects and features of certain embodiments of the present disclosure will be more apparent from the following description taken in conjunction with the accompanying drawings, in which:

FIG. 1A and FIG. 1B are views provided to schematically describe an electronic apparatus according to one or more embodiments;

FIG. 2 is a block diagram illustrating a configuration of an electronic apparatus according to one or more embodiments;

FIG. 3 is a flowchart provided to explain an operation method of an electronic apparatus according to one or more embodiments;

FIG. 4 is a flowchart provided to explain a method of re-identifying whether stains are removed according to one or more embodiments;

FIG. 5A is a flowchart provided to explain a method of performing cleaning by changing an image-capturing direction of a camera sensor according to one or more embodiments;

FIG. 5B is a view provided to explain a method of performing cleaning by changing an image-capturing direction of a camera sensor according to one or more embodiments;

FIG. 6A is a flowchart provided to explain a method of identifying whether stains are removed according to one or more embodiments;

FIG. 6B is a view provided to explain a method of identifying whether stains are removed according to one or more embodiments;

FIG. 7 is a flowchart provided to explain a method of providing guide information according to one or more embodiments;

FIG. 8 is a flowchart provided to explain a method of identifying whether a liquid is removed according to one or more embodiments; and

FIG. 9 is a block diagram illustrating a specific configuration of an electronic apparatus according to one or more embodiments.

### DETAILED DESCRIPTION

Hereafter, example embodiments of the present disclosure is specifically described with reference to the accompanying drawings.

Terms used herein are schematically described, and then the subject matter of the disclosure is specifically described.

General terms currently used as widely as possible are selected as the terms used in the embodiments of the disclosure in consideration of their functions in the disclosure, but may be changed based on the intention of those skilled in the art or a judicial precedent, the emergence of a new technology, or the like. In addition, in a specific case, terms arbitrarily chosen by the applicant may be included in the terms used herein. In this case, the meanings of such terms are described in detail in the corresponding descriptions of the disclosure. Therefore, the terms used in the disclosure need to be defined based on meanings thereof and particulars throughout the disclosure rather than simply names thereof.

In the disclosure, the expression “have”, “may have”, “include”, “may include” or the like, indicates the existence of a corresponding feature (e.g., a numerical value, a function, an operation or an element such as a part), and does not exclude the existence of an additional feature.

The expression of “at least one from A or B” is to be understood as indicating “A,” “B,” or “A and B”.

The expression “1st”, “2nd”, “first”, “second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), it is to be understood that one element may connect to another element directly, or through yet another element (e.g., a third element).

In the disclosure, singular forms include plural forms as well, unless explicitly indicated otherwise. In the disclosure, the term “include” or “comprised of” and the like specify the presence of stated features, numbers, steps, operations, elements, components or combinations thereof but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor except for a “module” or a “unit” that needs to be implemented by specific hardware.

Further, in the disclosure, the term “signal” may include a soundwave-from signal as well as an electrical signal, and in the case of an electrical signal, the signal may be a digital signal as well as an analogue signal. For example, the expression “audio signal (or noise signal)” may mean that the signal outside an electronic apparatus denotes a soundwave (or electric wave) signal, and that the signal in an electronic apparatus denotes an electrical signal, based on the position of the signal. Furthermore, signal processing and the like in an electronic apparatus, described hereafter, may be based on a signal processing method including an analogue signal processing method or a combination of an analogue signal processing method and a digital signal processing method as well as a digital signal processing method.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Additionally, in the disclosure, the term “filter” means to remove a specific component (e.g., a specific frequency area or a specific pattern), and may denote a digital filter or an analogue filter.

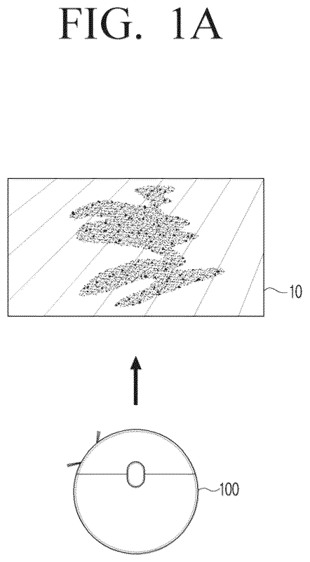

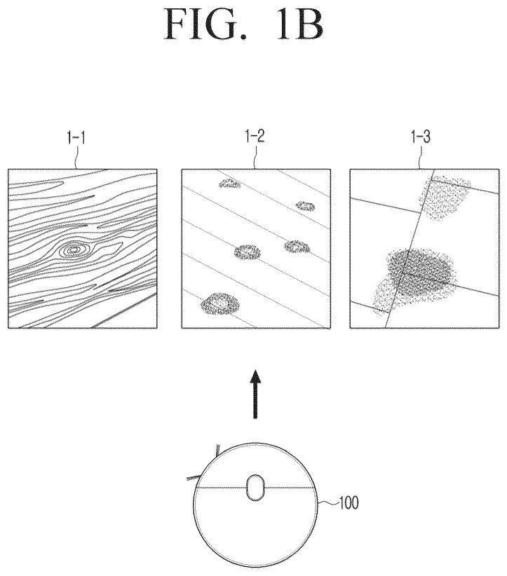

FIG. 1A and FIG. 1B are views provided to schematically describe an electronic apparatus according to one or more embodiments.

Referring to FIG. 1A and FIG. 1B, the electronic apparatus may perform a cleaning operation while traveling a travel space, according to one or more embodiments.

In one or more embodiments, the electronic apparatus may identify stains present in a travel space. The electronic apparatus may acquire an image of the travel space through a camera sensor. The electronic apparatus may identify whether one or more stains are present in the travel space by inputting the acquired image into a trained neural network model. In a case where it is identified that stains are present, the electronic apparatus may identify a cleaning mode for removing the stains and perform cleaning in the identified cleaning mode.

In one or more embodiments, the electronic apparatus may acquire an image of an area corresponding to the stains after the cleaning operation is completed. The electronic apparatus may identify whether the stains are removed by inputting the acquired image into the trained neural network model.

In a case where it is identified that the stains are removed, the electronic apparatus may travel the travel space along a travel path. Alternatively, in a case where it is identified that at least part of the stains remain, the electronic apparatus may perform cleaning again to remove the remaining stains. In a case where it is identified that the stains are not removed, the electronic apparatus may identify whether the pattern of the floor surface of a specific area in the travel space is likely to be falsely detected as a stain, or the electronic apparatus may perform cleaning again to remove the stains. Patterns likely to be falsely detected as a stain may include a wooden pattern 1-1, a furniture pattern 1-2, or a soot pattern 1-3, but the disclosure is not limited thereto.

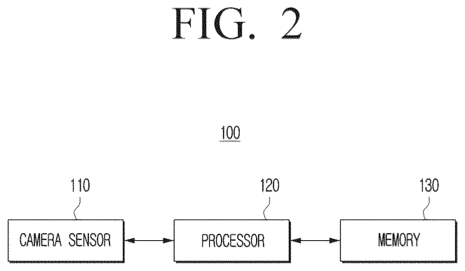

FIG. 2 is a block diagram illustrating a configuration of an electronic apparatus according to one or more embodiments.

Referring to FIG. 2, an electronic apparatus 100 may include a camera sensor 110, at least one processor 120, and memory 130.

The electronic apparatus 100 may be implemented as different types of apparatuses traveling the travel space. In one or more embodiments, the electronic apparatus 100 may be a robot that provides services to the user by moving to a specific position. For example, the electronic apparatus 100 may be implemented as a robot vacuum cleaner that performs a cleaning operation while traveling in the travel space. As one example, the electronic apparatus 100 may be different types of travel robots including a wheel robot, but the disclosure is not limited thereto.

According to one or more embodiments, the camera sensor 110 may include a lens that focuses, to an image sensor, visible light or other optical signals reflected and received from an object, and an image sensor that senses such visible light or other optical signals. Herein, the image sensor may include a 2D pixel array that is divided into a plurality of pixels. In one or more embodiments, the camera sensor 110 may be a stereo camera or an RGB (Red, Green, Blue) camera that is implemented as an IR camera, but the disclosure is not limited thereto. For example, the camera sensor 110 may be implemented as another type of sensor (e.g., a LiDAR sensor) different from the above-described sensor.

The at least one processor 120 (hereafter, “a processor”) may be electrically connected with the camera sensor 110 and the memory 130 and control the entire operation of the electronic apparatus 100. The processor 120 may be comprised of one processor or a plurality of processors. Specifically, the at least one processor 120 may perform the operations of the electronic apparatus 100 according to one or more embodiments by individually or collectively executing at least one instruction stored in the memory 130.

According to one or more embodiments, the processor 120 may be implemented as a digital signal processor (DSP) processing a digital image signal, a microprocessor, a graphics processing unit (GPU), an artificial intelligence (AI) processor, a neural processing unit (NPU), or a time controller (TCON). However, the processor 120 is not limited thereto, and may include one or more of a central processing unit (CPU), a micro controller unit (MCU), a micro processing unit (MPU), a controller, an application processor (AP), a communication processor (CP), or an ARM processor, or may be defined as such terms. Additionally, the processor 120 may be implemented in the form of a system on a chip (SoC) with an embedded processing algorithm, large scale integration (LSI), or implemented as an application specific integrated circuit (ASIC), a field programmable gate array (FPGA).

The memory 130 may store data required for one or more embodiments. The memory 130 may be implemented in the form of memory embedded in the electronic apparatus 100 or in the form of memory detachable from the electronic apparatus 100 depending on a data storage purpose. For example, in the case of data for driving the electronic apparatus 100, the data may be stored in the memory embedded in the electronic apparatus 100, and in the case of data for an expansion function of the electronic apparatus 100, the data may be stored in memory detachable from the electronic apparatus 100.

The memory embedded in the electronic apparatus 100 may be implemented in the form of at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)). Additionally, the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

According to one or more embodiments, the processor 120 may control the electronic apparatus 100 such that the electronic apparatus travels the travel space in a first cleaning mode. The electronic apparatus 100 may perform cleaning in different types of cleaning modes including the first cleaning mode, and the first cleaning mode may be a basic cleaning mode. The processor 120 may perform cleaning based on at least one of a compression level of a mop, an amount of water sprayed during cleaning, and a travel speed of the electronic apparatus 100 during cleaning that corresponds to each cleaning mode.

According to one or more embodiments, the processor 120 may acquire information on stains in the travel space. In one or more embodiments, the information on stains may include at least one of information as to whether or not stains are present in the travel space, or information on the position of stains present in the travel space. The processor 120 may acquire the information on stains in the travel space by inputting, to a trained first neural network model, a first image acquired through the camera sensor 110 during travel in the travel space while operating in the first cleaning mode.

In one or more embodiments, the processor 120 may acquire the first image of the travel space through the camera sensor 110, while the electronic apparatus 100 travels the travel space in the first cleaning mode. The first image may be an image obtained before a specific area in the travel space including stains is cleaned. In the case of a camera sensor 110 implemented as an IR sensor, the first image may be an IR image. Alternatively, in the case of a camera sensor 110 implemented as an RGB sensor, the first image may be an RGB image.

In one or more embodiments, in a case where an image of a specific area in the travel space is input, the trained first neural network model may be a model trained to identify whether or not stains are present in the specific area. In one or more embodiments, the trained first neural network model may be a model trained to classify an image depending on whether stains are included in the input image. In one or more embodiments, the trained first neural network model may be a model trained by using a label including an image of the travel space and information as to whether stains are present or not in the image as learning data.

According to one or more embodiments, the processor 120 may perform cleaning of a first area by changing the first cleaning mode to a second cleaning mode. In one or more embodiments, the second cleaning mode may be a mode different from the first cleaning mode, and may be a mode for removing stains. For example, in the second cleaning mode, a compression level of a mop and an amount of water sprayed may be greater than in the first cleaning mode, and a travel speed may be less than in the first cleaning mode, but the disclosure is not limited thereto.

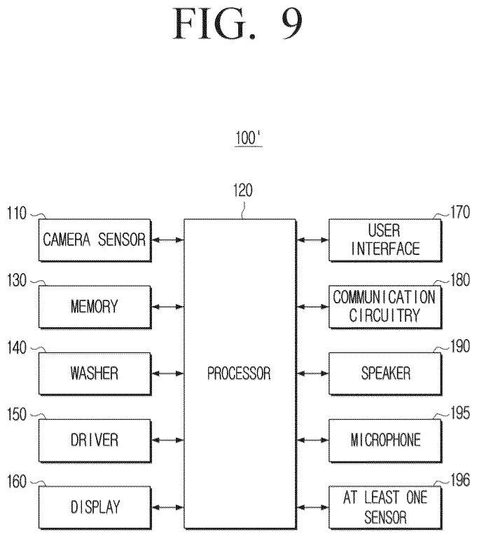

In one or more embodiments, in a case where stains are identified in a first area of the travel space based on the acquired information on stains, the processor 120 may cause the electronic apparatus to perform cleaning of the first area by changing the first cleaning mode to the second cleaning mode for removing stains. In one or more embodiments, the electronic apparatus 100 may include a washer (e.g., a washer 140 of FIG. 9) for performing cleaning of the travel space. In one or more embodiments, the washer may include a mop and a roller, and the processor 120 may control the washer to perform cleaning of the first area.

In one or more embodiments, in a case where stains are identified in the first area, the processor 120 may perform a pre-set cleaning operation for removing the stains. For example, the processor 120 may perform a cleaning operation based on a set value corresponding to the second cleaning mode for pre-set time. As used herein, “completion of cleaning” may denote completion of a pre-set cleaning operation for removing stains. Accordingly, even in a case where the cleaning of the first area is completed, the stains in the first area may not be removed completely. In such a situation, the processor 120 may cause the electronic apparatus to perform an operation for identifying whether the stains are removed completely as described hereafter.

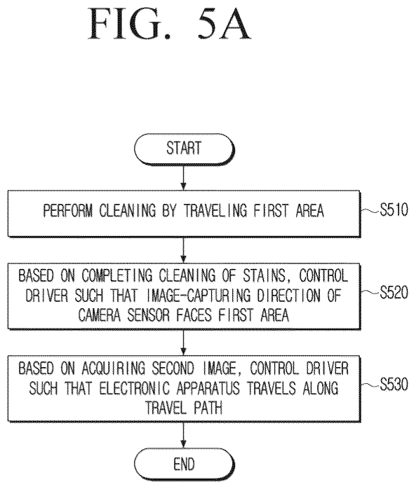

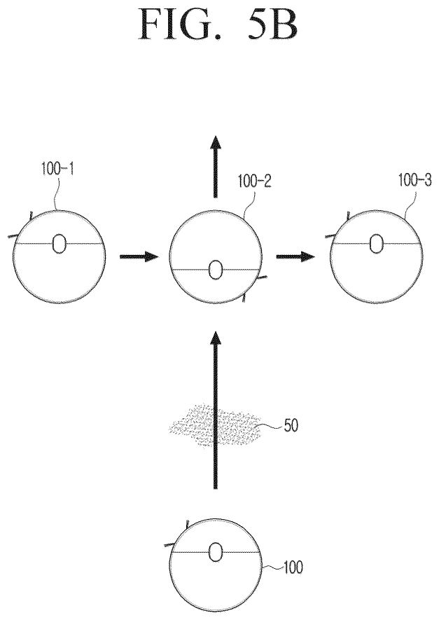

According to one or more embodiments, the processor 120 may acquire a second image of the first area. The second image, as an image that is acquired after the first area is cleaned, may be an image corresponding to an area identical with the area of the first image. As the cleaning of the first area is completed, the processor 120 may acquire a second image of the first area through the camera sensor 110. For example, as the cleaning of the first area is completed, the processor 120 may control the electronic apparatus 100 such that an image-capturing direction of the camera sensor 110 faces the first area, and based on this, may acquire the second image of the first area. Detailed description in relation to this is provided with reference to FIG. 5A and FIG. 5B.

According to one or more embodiments, the processor 120 may identify whether the stains are removed. The processor 120 may identify whether the stains are removed by inputting, into a trained second neural network model, the acquired first image and the acquired second image.

In one or more embodiments, in a case where an image before cleaning and an image after cleaning are input into the trained second neural network model, the trained second neural network model may be a model trained to output whether stains are removed by comparing the input images. The cleaning described above may denote cleaning for removing stains. Based on acquiring a plurality of captured images of an identical area, the trained second neural network model may be a model trained to recognize a target object (e.g., a stain) in each of the captured images, and by using results of the recognition, to determine whether the stains are removed.

In one or more embodiments, the processor 120 may identify whether the stains in the first area are removed based on output data acquired from the trained second neural network model. In a case where it is identified that a change occurs to an image corresponding to a target object in the first image and an image corresponding to a target object in the second image, based on the output data, the processor 120 may identify that at least part of the stains are removed and/or at least part of the stains remain. In a case where it is identified that at least part of the stains remain, the processor 120 may perform cleaning of the first area again in the second cleaning mode.

Alternatively, in a case where it is identified that no change occurs to the image corresponding to the target object even after the cleaning is completed, the processor 120 may also identify that stains are not included in the first area. For example, in the case where no change occurs to the image corresponding to the target object based on the acquired output data, the processor 120 may identify the target object as a pattern (e.g., a wooden pattern, a furniture pattern or a soot pattern and the like). In a case where the target object is identified as a pattern, the processor 120 may store information on the pattern in the memory 130.

According to one or more embodiments, in the case where it is identified that the stains are removed, the processor 120 may change the second cleaning mode to the first cleaning mode and cause the electronic apparatus to travel in the travel space. In one or more embodiments, the processor 120 may identify whether the stains in the first area are removed based on the output data acquired from the trained second neural network model. In a case where it is identified that the stains are removed, the processor 120 may end the second cleaning mode, change the cleaning mode to the first cleaning mode, and cause the electronic apparatus to travel in the travel space.

According to one or more embodiments, the processor 120 may also identify whether stains are present in the first area based on cleaning history information. In one or more embodiments, the processor 120 may identify the stains in the first area based on at least one of the output data acquired from the trained first neural network model and history information in association with cleaning.

In one or more embodiments, the cleaning history information may include information on an area of which the cleaning of stains is completed in the travel space. For example, the cleaning history information may include information on the position of a specific area in the travel space and a time where the electronic apparatus 100 performed cleaning in the second cleaning mode in the past. The cleaning history information may include information on the position of an area and a time where the electronic apparatus 100 has performed cleaning in the second cleaning mode most recently, but the disclosure is not limited thereto, and the cleaning history information may also include information on the position of an area and a time where the electronic apparatus 100 performs cleaning in the second cleaning mode during a pre-set period of time (e.g., one month).

In one or more embodiments, the cleaning history information may include information on the position of a pattern in the travel space. For example, in a case where a target object is identified as a pattern based on the output data acquired from the trained second neural network model, the processor 120 may update the cleaning history information such that information on the position of the identified pattern in the travel space may be included in the cleaning history information. However, the cleaning history information may not be limited thereto, and the information on the position of a pattern in the travel space may be acquired based on a user input.

In one or more embodiments, it may be assumed that a pattern is included in the first area. Even in a case where output data indicating that stains are included in the first area is acquired from the trained first neural network model, the processor 120 may identify that the stains are not present in the first area, based on the cleaning history information. In a case where the stains are not present in the first area, the processor 120 may perform cleaning in the existing first cleaning mode.

According to one or more embodiments, the processor 120 may update the cleaning history information based on user feedback information. In one or more embodiments, the processor 120 may provide a user interface (UI) for acquiring user feedback information after the cleaning is completed. In one or more embodiments, the processor 120 may acquire the user feedback information through the UI. In one or more embodiments, the user feedback information may include an evaluation of cleaning performance of the electronic apparatus 100 such as “The stains are removed perfectly.”, “The pattern of the floor surface is wrongly recognized as a stain.”, or “The stains are not removed perfectly.”

In one or more embodiments, the processor 120 may update the cleaning history information based on the feedback information. For example, based on acquiring a user feedback indicating that the stains are not removed perfectly, the processor 120 may add the user feedback to the cleaning history information, and later may increase the intensity of cleaning to remove the stains present in the first area. Alternatively, based on acquiring a user feedback indicating that the pattern is wrongly recognized as a stain, the processor 120 may add, to the cleaning history information, information indicating that the cleaning of the first area is performed although stains are not included in the first area.

In the above-described example, the electronic apparatus 100 may accurately identify stains present in the travel space by using a neural network model, and may perform cleaning in a cleaning mode for removing stains, to remove the stains. In the above-described example, the electronic apparatus 100 may identify stains present in the travel space considering a history of cleaning of the travel space, and accordingly, a false detection rate of stains may decrease.

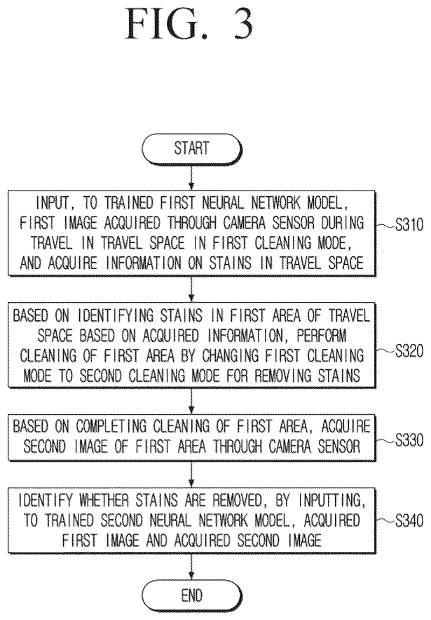

FIG. 3 is a flowchart provided to explain an operation method of an electronic apparatus according to one or more embodiments.

Referring to FIG. 3, according to one or more embodiments, the operation method may include inputting, to a trained first neural network model, a first image acquired through a camera sensor 110 during travel in a travel space in a first cleaning mode, and acquiring information on stains in the travel space (S310).

In one or more embodiments, the electronic apparatus 100 may travel the travel space in the first cleaning mode. In one or more embodiments, the electronic apparatus 100 may acquire a first image corresponding to a first area in the travel space through the camera sensor 110 while traveling in the travel space. In one or more embodiments, the electronic apparatus 100 may acquire information on stains present in the travel space, by inputting the acquired first image to the trained first neural network model.

According to one or more embodiments, the operation method may include changing the first cleaning mode to a second cleaning mode for removing stains and performing cleaning of the first area in a case where the stains in the first area of the travel space are identified based on the acquired information (S320).

In one or more embodiments, based on acquiring the information on the stain, the electronic apparatus 100 may identify whether the stains are present in the first area of the travel space based on the acquired information. In a case where the stains are identified, the electronic apparatus 100 may change the first cleaning mode to the second cleaning mode for removing the stains. In one or more embodiments, the electronic apparatus 100 may perform cleaning of the first area while traveling the travel space in the second cleaning mode.

According to one or more embodiments, in the case where the cleaning of the first area is completed, the operation method may include acquiring a second image of the first area through the camera sensor 110 (S330).

As one example, in the case where the cleaning of the first area is completed, the electronic apparatus 100 may acquire a second image of the first area. As one example, the second image may be an image different from the first image.

According to one or more embodiments, the operation method may include inputting the acquired first image and the acquired second image to a trained second neural network model, and identifying whether the stains are removed (S340).

As one example, the electronic apparatus 100 may identify whether the stains are removed by inputting, to the trained second neural network model, the acquired first image and the acquired second image. As one example, the trained second neural network model may be a model different from the trained first neural network model, but the disclosure is not limited thereto, and as one example, the trained second neural network model may be implemented as a model identical with the trained first neural network model).

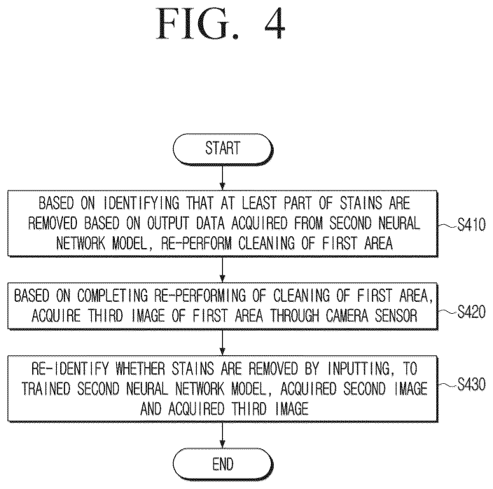

FIG. 4 is a flowchart provided to explain a method of re-identifying whether stains are removed according to one or more embodiments.

Referring to FIG. 4, according to one or more embodiments, the operation method may include re-performing cleaning of the first area, in the case where it is identified that at least part of the stains are removed based on output data acquired from the trained second neural network model (S410).

In one or more embodiments, the electronic apparatus 100 may identify whether the stains are removed by inputting, to the trained second neural network model, the first image before cleaning of the first area and the second image after cleaning of the first area. In one or more embodiments, the second image may be an image that is captured after the cleaning is completed. In one or more embodiments, the trained second neural network model may output information as to whether the stains in the first area are removed by comparing the first image and the second image. Alternatively, the trained second neural network model may output information as to whether a change occurs to the stains in the first area. For example, the trained second neural network model may output information as to whether at least part of the stains in the first area are removed, or may also output information indicating that the stains are still present in first area.

In one or more embodiments, the trained second neural network model may output data as to whether the stains are removed, by comparing an image corresponding to the stains in the input first image and an image corresponding to the stains in the input second image and determining whether there is any difference between the images corresponding to the stains.

In a case where it is identified that at least part of the stains are removed, the electronic apparatus 100 may re-perform cleaning of the first area in the second cleaning mode. Alternatively, in a case where it is identified that no change occurs between the images corresponding to the stains even after cleaning is completed, the electronic apparatus 100 may also identify that stains are not included in the first area. Description in relation to this is provided hereafter.

According to one or more embodiments, the operation method may include acquiring a third image of the first area through the camera sensor 110 in the case where the re-performing of cleaning of the first area is completed (S420).

In a case where the re-performing of cleaning of the first area is completed, the electronic apparatus 100 may acquire a third image of the first area through the camera sensor 110. For example, the electronic apparatus 100 may re-perform a pre-set cleaning operation for removing stains based on the second cleaning mode. In the case where the cleaning operation is completed, the electronic apparatus 100 may acquire the third image of the first area through the camera sensor 110. In a case where the re-performing of cleaning is completed, the electronic apparatus 100 may acquire the third image by changing a travel direction of the electronic apparatus 100 such that an image-capturing direction of the camera sensor 110 may face the first area.

According to one or more embodiments, the operation method may include inputting, to the trained second neural network model, the acquired second image and the acquired third image, and re-identifying whether the stains are removed (S430).

In one or more embodiments, based on acquiring the third image, the electronic apparatus 100 may re-identify whether the stains are removed by inputting, to the trained second neural network model, the acquired second image and third image.

In one or more embodiments, in the case where it is identified that the stains are removed based on results of the re-identification, the electronic apparatus 100 may travel the travel space along a pre-set travel path. In this case, the electronic apparatus 100 may change the second cleaning mode to the first cleaning mode and travel the travel space.

In a case where it is identified that the stains are not removed perfectly based on results of the re-identification, the electronic apparatus 100 may repeat cleaning the first area in the second cleaning mode. In one or more embodiments, the electronic apparatus 100 may re-perform cleaning pre-set times (e.g., five times). For example, the electronic apparatus 100 may re-perform cleaning in the second cleaning mode pre-set times until the stains are removed. However, the pre-set times may not be limited thereto, and may vary.

FIG. 5A is a flowchart provided to explain a method of performing cleaning by changing an image-capturing direction of a camera sensor according to one or more embodiments. FIG. 5B is a view provided to explain a method of performing cleaning by changing an image-capturing direction of a camera sensor according to one or more embodiments.

Referring to FIG. 5A and FIG. 5B, according to one or more embodiments, the operation method may include traveling the first area and performing cleaning (S510).

In one or more embodiments, the electronic apparatus 100 may perform cleaning of the first area by traveling the first area in the second cleaning mode. For example, the electronic apparatus 100 may perform cleaning of the first area while moving in the first area. In one or more embodiments, the electronic apparatus 100 may perform cleaning by moving to the position of stains 50 present in the first area.

According to one or more embodiments, the operation method may include controlling a driver of the electronic apparatus 100 such that the image-capturing direction of the camera sensor may face the first area in the case where the cleaning of the stains 50 is completed (S520).

In one or more embodiments, the electronic apparatus 100 may include a driver (e.g., a driver 150 of FIG. 9). In a case where the cleaning of the stains 50 is completed, the electronic apparatus 100 may control the driver such that the image-capturing direction of the camera sensor may face the first area to capture a second image of the first area after the cleaning is completed.

For example, as illustrated in FIG. 5B, the electronic apparatus 100 may change the travel direction from a travel direction 100-1 after the cleaning of the stains 50 is completed to a travel direction 100-2 in which the image-capturing direction of the camera sensor faces the first area, by controlling the driver. In one or more embodiments, the image-capturing direction of the camera sensor may be identical with the travel direction of the electronic apparatus 100, but the disclosure is not limited thereto.

According to one or more embodiments, the operation method may include controlling the driver such that the electronic apparatus 100 may travel along a travel path, based on acquiring the second image (S530).

In a case where the image-capturing direction is changed to the travel direction 100-2 facing the first area, the electronic apparatus 100 may acquire the second image through the camera sensor. In a case where the second image is acquired, the electronic apparatus 100 may control the driver such that the travel direction of the electronic apparatus 100 may be changed to a travel direction 100-3 corresponding to the travel path. In a case where the travel direction is changed to the travel direction 100-3 corresponding to the travel path, the electronic apparatus 100 may travel the travel space in the changed travel direction.

In the above-described example, the electronic apparatus 100 may re-capture an image of the area in which the stains 50 are present to identify whether the stains 50 are removed after cleaning for removing the stains 50 is performed.

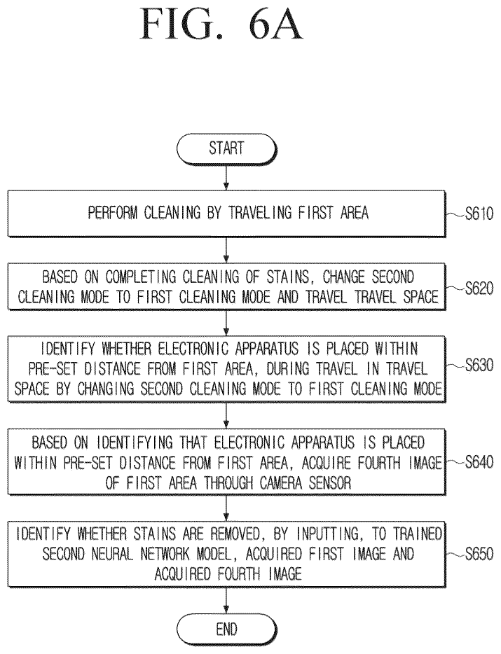

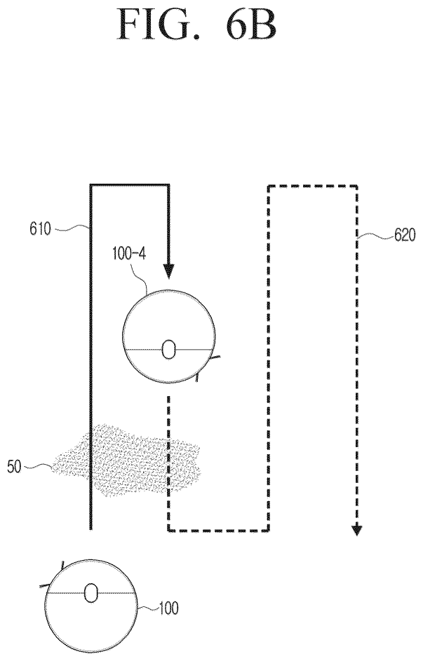

FIG. 6A is a flowchart provided to explain a method of identifying whether stains are removed according to one or more embodiments. FIG. 6B is a view provided to explain a method of identifying whether stains are removed according to one or more embodiments.

Referring to FIG. 6A and FIG. 6B, according to one or more embodiments, the operation method may include performing cleaning by traveling the first area (S610).

In one or more embodiments, the electronic apparatus 100 may perform cleaning of the first area by traveling the first area in the second cleaning mode. For example, the electronic apparatus 100 may perform cleaning of the first area while moving in the first area. In one or more embodiments, the electronic apparatus 100 may perform cleaning by moving to the position of the stains 50 present in the first area.

According to one or more embodiments, the operation method may include changing the second cleaning mode to the first cleaning mode and traveling the travel space after the cleaning of the stains 50 is completed (S620).

In one or more embodiments, the electronic apparatus 100 may include a driver (a driver 150 of FIG. 9). In a case where the cleaning of the stains 50 is completed, the electronic apparatus 100 may control the driver to travel along a pre-set travel path (610 and 620). In one or more embodiments, the pre-set travel path 610 and 620 may be a path along which cleaning of the travel space is performed.

In one or more embodiments, after the cleaning of the stains 50 is completed, the electronic apparatus 100 may change the second cleaning mode to the first cleaning mode, and may travel the travel space in the first cleaning mode. In this case, unlike what is illustrated in FIG. 5A and FIG. 5B, the electronic apparatus 100 may not change the travel direction to acquire the second image, and may travel the travel space along a first travel path 610 after the cleaning of the stains 50 is completed.

According to one or more embodiments, the operation method may include identifying whether the electronic apparatus 100 is within a pre-set distance from the first area while the electronic apparatus changes the cleaning mode to the first cleaning mode and travels in the travel space (S630). In one or more embodiments, the electronic apparatus 100 may identify whether the electronic apparatus is within a pre-set distance from the first area, while the electronic apparatus travels in the travel space along the first travel path 610.

In one or more embodiments, the electronic apparatus 100 may identify whether the electronic apparatus is within the pre-set distance from the first area, based on the position of the first area and the position of the electronic apparatus 100 in the travel space. In one or more embodiments, the electronic apparatus 100 may store information on the first area in a case where cleaning of the first area is performed. For example, the electronic apparatus 100 may store information on the position of the first area. In one or more embodiments, the electronic apparatus 100 may identify whether the electronic apparatus 100 is within the pre-set distance from the first area by comparing the position of the first area and the position of the electronic apparatus 100.

According to one or more embodiments, the operation method may include acquiring a fourth image of the first area through the camera sensor in the case where it is identified that the electronic apparatus is within the pre-set distance from the first area (S640). The fourth image may be an image that is acquired after the cleaning of the first area is completed.

In a case where it is identified that the electronic apparatus 100 is within the pre-set distance from the first area while traveling the travel space along the first travel path, the electronic apparatus 100 may acquire a fourth image of the first area through the camera sensor. In a case where a travel direction 100-4 of the electronic apparatus 100 is a direction in which image-capturing of the first area is possible as illustrated in FIG. 6B, the electronic apparatus 100 may acquire the fourth image without performing an additional direction change operation.

Alternatively, in a case where the travel direction of the electronic apparatus 100 is a direction in which image-capturing of the first area is impossible (unlike what is illustrated in FIG. 6B), the electronic apparatus 100 may control the driver such that the image-capturing direction of the camera sensor may face the first area. In a case where it is identified that the travel direction of the electronic apparatus 100 (or the image-capturing direction of the camera sensor) faces the first area, the electronic apparatus 100 may acquire the fourth image through the camera sensor.

According to one or more embodiments, the operation method may include inputting, to the trained second neural network model, the acquired first image and the acquired fourth image, and identifying whether the stains 50 are removed (S650).

In a case where the fourth image is acquired, the electronic apparatus 100 may identify whether the stains 50 are removed by inputting, to the trained second neural network model, the acquired first image and the acquired fourth image. In one or more embodiments, the electronic apparatus 100 may identify whether the stains 50 included in the first area are removed by comparing the first image and the fourth image.

In a case where the fourth image is acquired, the electronic apparatus 100 may travel the travel space along a second travel path 620. In a case where it is identified that the stains 50 are removed, the electronic apparatus 100 may travel the travel space along the second travel path 620 while maintaining the existing first cleaning mode without changing the first cleaning mode to the second cleaning mode, based on output data acquired from the trained second neural network model. Alternatively, in a case where it is identified that at least part of the stains 50 are not removed, the electronic apparatus 100 may also change the first cleaning mode to the second cleaning mode, perform cleaning of the first area, and then travel the travel space along the second travel path 620.

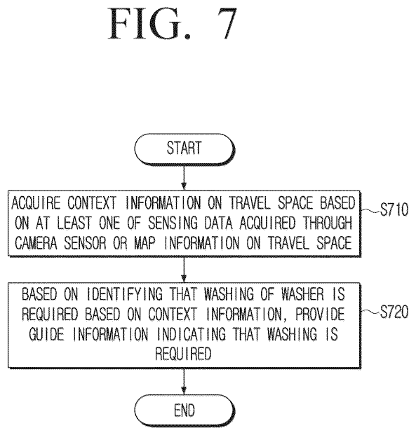

FIG. 7 is a flowchart provided to explain a method of providing guide information according to one or more embodiments.

Referring to FIG. 7, according to one or more embodiments, the operation method may include acquiring context information on the travel space based on at least one of sensing data acquired through the camera sensor 110 or map information on the travel space (S710).

In one or more embodiments, the sensing data acquire through the camera sensor 110 may be image-type data. In one or more embodiments, the map information on the travel space may include information on the type and position of at least one object present in the travel space, together with a map corresponding to the travel space. In one or more embodiments, the type of the object may denote a training pad for a companion animal, a kitchen or a table, but not be limited thereto.

In one or more embodiments, the context information on the travel space may be context information in association with stains present in the travel space. For example, in the case where a training pad is present around the first area where stains are present, a context such as “stains caused by waste of a companion animal” may be identified. Alternatively, for example, in the case where a kitchen is present around the first area where stains are present, a context such as “stains based on a food item” may be identified.

According to one or more embodiments, in the case where is it identified that washing of the washer is required based on the context information, the operation method may include providing guide information indicating that washing is needed (S720).

In one or more embodiments, the electronic apparatus 100 may further include a washer (e.g., a washer 140 of FIG. 9). In one or more embodiments, the electronic apparatus 100 may identify whether washing of a mop included in the washer is required based on the context information. For example, in the case where it is identified that stains present in the first area identified as “stains caused by waste of a companion animal, or “stains based on a food item”, the electronic apparatus 100 may identify that washing of the washer is required regardless of a contamination level of the travel space. As one example, the electronic apparatus 100 may identify whether washing of the washer is required after cleaning of the stains present in the first area is performed.

In one or more embodiments, the electronic apparatus 100 may provide guide information indicating that washing is required. For example, the electronic apparatus 100 may include a display. The electronic apparatus 100 may provide a UI including guide information indicating that washing is required through the display. Alternatively, the electronic apparatus 100 may output an audio indicating that washing is required through a speaker.

Alternatively, In one or more embodiments, the electronic apparatus 100 may perform an operation of washing the washer without providing guide information. For example, in the case where it is identified that washing of the washer is required, the electronic apparatus 100 may move to a docking state to perform the washing operation, but not be limited thereto.

In one or more embodiments, the electronic apparatus 100 may identify whether washing of the washer is required based on a contamination level. For example, the electronic apparatus 100 may include a sensor capable of measuring a contamination level of the washer. In one or more embodiments, the sensor capable of measuring a contamination level of the washer may include an RGB sensor capable of sensing a change in the color of water used to perform a cleaning operation, or a different type of sensor including an optical sensor for measuring a contamination level of the washer by sensing dust accumulated on the surface of the mop. The electronic apparatus 100 may measure a contamination level of the washer based on sensing data acquired from the sensor, and based on the measured contamination level, may identify whether washing of the washer is required. In a case where it is identified that the contamination level of the washer is greater than or equal to a pre-set value, the electronic apparatus 100 may identify that washing of the washer is required. Alternative, for example, the electronic apparatus 100 may also identify whether washing of the washer is required based on time for which the cleaning operation is performed.

In a case where it is identified that washing of the washer is required, the electronic apparatus 100 may perform the washing operation. For example, the electronic apparatus 100 may move to a docking station to perform the washing operation on the washer.

In the above-described example, the electronic apparatus may determine whether to wash the washer based on a context on the travel space. Accordingly, in the case where the washer is contaminated because of cleaning of stains caused by waste of a puppy or stains based on a food item, and the like, the electronic apparatus 100 may prevent a situation where stains occur in other areas due to the stains on the washer.

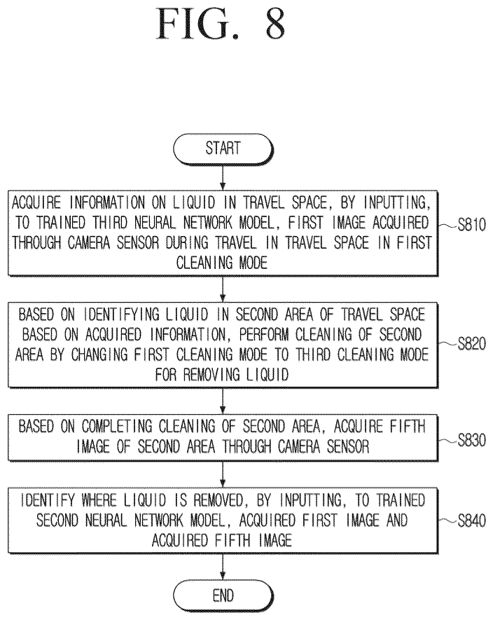

FIG. 8 is a flowchart provided to explain a method of identifying whether a liquid is removed according to one or more embodiments.

Referring to FIG. 8, according to one or more embodiments, the operation method may include acquiring information on a liquid in the travel space by inputting, to a trained third neural network model, a first image acquired through the camera sensor 110 during travel in the travel space in the first cleaning mode (S810).

In one or more embodiments, the electronic apparatus 100 may input the first image to the trained third neural network model. In a case where an image of the travel space is input, the third neural network model may be a model trained to sense whether a liquid is present in the input image. In one or more embodiments, the electronic apparatus 100 may acquire information on a liquid by inputting the first image to the trained third neural network model. In one or more embodiments, the information on a liquid may include at least one of information as to whether a liquid is present in the travel space, or information on the position of a liquid present in the travel space. In a case where a liquid is identified in a second area, the first image may be an image of the second area.

According to one or more embodiments, in the case where a liquid is identified in the second area of the travel space based on the acquired information, the operation method may include performing cleaning of the second area by changing the first cleaning mode to a third cleaning mode for removing a liquid (S820).

In one or more embodiments, the electronic apparatus 100 may identify a liquid present in the travel space, based on output data acquired from the trained third neural network model. In a case where a liquid is identified in the second area, the electronic apparatus 100 may change the first cleaning mode to a third cleaning mode for removing a liquid. In one or more embodiments, the electronic apparatus 100 may perform cleaning of the second area in the third cleaning mode. Unlike the second cleaning mode, the third cleaning mode may be a mode in which the travel space is cleaned by using a dry mop without spraying water.

According to one or more embodiments, the operation method may include acquiring a fifth image of the second area through the camera sensor 110, in the case where the cleaning of the second area is completed (S830).

In a case where the liquid is identified in the second area, the electronic apparatus 100 may perform a pre-set cleaning operation for removing a liquid. For example, for pre-set time, the electronic apparatus 100 may perform a cleaning operation based on a set value corresponding the third cleaning mode.

In the case where the cleaning of the second area is completed, the electronic apparatus 100 may acquire a fifth image of the second area through the camera sensor 110. In one or more embodiments, the fifth image, as an image acquired after the second area cleaned, may be an image corresponding to an area identical with the area of the first image, but may be an image corresponding to an area different from the area of the first image. The fifth image may also be an image including a liquid like the first image.

According to one or more embodiments, the operation method may include identifying whether a liquid is removed by inputting, to the trained second neural network model, the acquired first image and the acquired fifth image (S840).

In a case where a fifth image is acquired, the electronic apparatus 100 may identify whether the liquid in the second area is removed, by inputting, to the trained second neural network model, the acquired first image and the acquired fifth image. In a case where it is identified that the liquid is removed, the electronic apparatus 100 may change the third cleaning mode to the first cleaning mode and travel the travel space.

FIG. 9 is a block diagram illustrating a specific configuration of an electronic apparatus according to one or more embodiments.

Referring to FIG. 9, an electronic apparatus 100′ may include a camera sensor 110, at least one processor 120, memory 130, a washer 140, a driver 150, a display 160, a user interface 170, communication circuitry 180, a speaker 190, a microphone 195 and at least one sensor 196. Detailed description of elements overlapping those illustrated in FIG. 2 is avoided among the elements illustrated in FIG. 9.

The washer 140 may include at least one object for the electronic apparatus 100′ to perform cleaning. In one or more embodiments, the washer 140 may include at least one of a wet mop or a dry mop. In one or more embodiments, the washer 140 may perform cleaning by rotating a roller attached to at least one of the wet mop or the dry mop. However, the washer may not be limited thereto, and may perform cleaning by using an object different from the above-described object.

The driver 150 is a device enabling the electronic apparatus 100′ to travel. The driver 150 may adjust a travel direction and a travel speed under the control of the processor 120, and In one or more embodiments, the driver 150 may include a power generation device (e.g., a gasoline engine, a diesel engine, a liquefied petroleum gas (LPG) engine, an electric motor and the like that generate power to enable the electronic apparatus 100′ to travel, based on a fuel (or an energy source) for use), a steering device for adjusting a travel direction (e.g., a manual steering, hydraulics steering, electronic control power steering (EPS) and the like), a travel device (e.g., wheels, a propeller and the like) enabling the electronic apparatus 100′ to travel based on power. Herein, the driver 150 may be modified depending on a travel type (e.g., a wheel type, a walking type, a flying type and the like) of the electronic apparatus 100′.

The display 160 may be implemented as a display including a self-light emitting element, or a display including a non-self-light emitting element and backlight. For example, the display 160 may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode and the like. In the display 160, driving circuitry implementable in the form of an a-si TFT, a low temperature poly silicon (LTPS) TFT, an organic TFT (OTFT) and the like, and a backlight unit may be included together. The display 160 may be implemented as a touch screen coupled with a touch screen, a flexible display, a rollable display, a 3D display, a display in which a plurality of display modules is physically connected, and the like. The processor 120 may control the display 160 to output an output image acquired according to the above-described embodiments. Herein, the output image may be an image of high resolution greater than or equal to 4K or 8K. The output image may also be a game image according to one or more embodiments.

According to one or more embodiments, the display 160 may include a plurality of haptic elements. The haptic elements may be implemented as a motor for providing a haptic feedback (e.g., a vibration feedback) to the user, but the disclosure is not limited thereto. In one or more embodiments, the display 160 may include a pre-set number of haptic elements. For example, the display 160 may include a pre-set number of haptic elements corresponding to a pre-set number of sub areas of the display, but not be limited thereto, and the display may include haptic elements of a number different from the number of a plurality of sub areas corresponding to the display.

The user interface 170 is an element for performing an interaction of the electronic apparatus 100′ with the user. For example, the user interface 170 may include at least one of a touch sensor, a motion sensor, a button, a jog, a dial, a switch, a microphone or a speaker, but not be limited thereto.

The communication circuitry 180 may input and output various types of data. For example, the communication circuitry 180 may transceive various types of data with an external device (e.g., a source device), an external storage medium (e.g., USB memory), an external server (e.g., a webhard) based on a communication method such as AP-based Wi-Fi (Wi-Fi, Wireless LAN Network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial and the like.

In one or more embodiments, the communication circuitry 180 may include a Bluetooth Low Energy (BLE) module. The BLE denotes a Bluetooth technology enabling transmission and reception of low-power low-capacity data in a 2.4-GHz frequency band having a reach radius of about 10 m. However, the communication circuitry 180 may not be limited thereto, and may include a Wi-Fi communication module. That is, the communication circuitry 180 may include at least one of a Bluetooth Low Energy (BLE) module or a Wi-Fi communication module.

According to one or more embodiments, the speaker 190 may be comprised of a tweeter for replaying a sound in a high vocal range, a midrange for replaying a sound in an intermediate vocal range, a woofer for replaying a sound in a low vocal range, a subwoofer for replaying a sound in an extremely low vocal range, an enclosure for controlling resonance, a crossover network dividing an electrical signal frequency input to the speaker based on each band, and the like.

According to one or more embodiments, the speaker 190 may output an acoustic signal to the outside of the electronic apparatus 100′. The speaker 190 may output a multimedia replay, a recording replay, various notification sounds, a voice message and the like. The electronic apparatus 100′ may include an audio output device such as a speaker 190, but may also include an input device such as an audio output terminal. In particular, the speaker 190 may provide acquired information, information processed/generated based on the acquired information, a response result or an operation result to a user voice and the like, in the form of a voice.

The microphone 195 may denote a module acquiring a sound and converting the sound into an electrical signal, and may be a condenser microphone, a ribbon microphone, a moving coil microphone, a piezoelectric microphone, a carbon microphone, or a micro electro mechanical system (MEMS) microphone. Additionally, the microphone 195 may be implemented based on an omnidirectional method, a bidirectional method, a uni-directional method, a sub cardioid method, a super cardioid method, or a hyper cardioid method. According to one or more embodiments, the electronic apparatus 100′ may include the microphone 195 and an inner microphone, and the microphone 195 may be a microphone disposed at a relatively outward side of the body. In one or more embodiments, the electronic apparatus 100′ may acquire an audio signal including an external noise through the microphone 195. According to one or more embodiments, the microphone 195 may be disposed in a direction opposite to a direction in which the speaker 190 emits a sound.

The at least one sensor 196 may be implemented as a different type of sensor including a LiDAR sensor, an ultrasonic sensor, an acceleration sensor, an angular velocity sensor, and a gyro sensor. In one or more embodiments, the at least one sensor 196 may include an RGB sensor. However, the at least one sensor 196 may not be limited thereto, and may include a sensor different from the RGB sensor.

In the above-described example, the electronic apparatus 100 may accurately identify stains present in the travel space by using a neural network model and perform cleaning in a cleaning mode for removing stains, to remove the stain. In the above-described example, the electronic apparatus 100 may identify stains present in the travel space considering a cleaning history of the travel space, and accordingly, a false detection rate of stains may decrease.

The embodiments described above may be implemented with software including instructions stored in a storage medium readable by a machine (e.g., a computer). The machine, as a device capable of calling the stored instructions from the storage medium and operating according to the called instructions, may include a display device (e.g., display device A) according to the disclosed embodiments. Based on instructions executed by a processor, the processor may perform functions corresponding to the instructions directly or by using other elements under the control of the processor. The instructions may include a code provided or executed by a compiler or an interpreter. The machine-readable storage medium may be provided in the form of a non-transitory storage medium. Herein, the term “non-transitory” means that the storage medium does not include a signal and only means that the storage medium is tangible, while the term does not differentiate semi-permanent or temporary storage of data in the storage medium.

According to the embodiments described above, the methods may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play-Store™). In the case of online distribution, at least part of the computer program product may be stored at least temporarily, or provided temporarily in a storage medium such as a server of a manufacturer, a server of an application store, or memory of a relay server.

Further, each of the elements (e.g., a module or a program) according to the embodiments described above may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform identical or similar functions performed by each corresponding element prior to integration. Operations performed by a module, a program, or another element, according to the embodiments, may be executed sequentially, in parallel, repetitively, or heuristically, or at least some of the operations may be executed in a different order, omitted, or may add a different operation.

While example embodiments of the present disclosure are illustrated and described above, embodiments of the disclosure are not limited to specific embodiments set forth herein, and various modifications thereof may be made by those skilled in the art to which the present disclosure pertains, without departing from the scope the disclosure claimed in the section of claims, and should not be understood as separating from the technical spirit or prospect of the disclosure.

What is claimed is:

1. An electronic apparatus comprising:
a camera sensor;
memory storing instructions; and
at least one processor comprising processing circuitry, and
wherein the instructions, when executed by the at least one processor individually or collectively, cause the electronic apparatus to:
acquire information on one or more stains in a travel space by inputting, to a trained first neural network model, a first image acquired through the camera sensor, wherein the first image is acquired while the electronic apparatus travels in the travel space in a first cleaning mode;
based on identifying a stain in a first area of the travel space, among the one or more stains, based on the acquired information, perform cleaning of the first area by changing the first cleaning mode to a second cleaning mode;
based on completion of the performing the cleaning of the first area, acquire a second image of the first area through the camera sensor; and
identify whether the stain is removed by inputting, to a trained second neural network model, the acquired first image and the acquired second image.

2. The electronic apparatus of claim 1, wherein the trained first neural network model is trained to, based on inputting an image of the first area, identify whether a stain is present in the first area, and
wherein the trained second neural network model is trained to, based on inputting input images comprising an image obtained before performing the cleaning of the first area and an image obtained after performing the cleaning of the first area, identify whether a stain previously identified in the first area has been removed by comparing the input images.

3. The electronic apparatus of claim 1, wherein the instructions, when executed by the at least one processor individually or collectively, further cause the electronic apparatus to identify the stain in the first area based on output data acquired from the trained first neural network model and cleaning history information, and
wherein the cleaning history information comprises information on an area of the travel space in which cleaning was previously performed.

4. The electronic apparatus of claim 1, wherein the instructions, when executed by the at least one processor individually or collectively, further cause the electronic apparatus to:
based on identifying that at least part of the stain remains based on output data acquired from the trained second neural network model, re-perform cleaning of the first area;
based on completion of the re-performing the cleaning of the first area, acquire a third image of the first area through the camera sensor; and
re-identify whether the stain is removed by inputting, to the trained second neural network model, the acquired second image and the acquired third image.

5. The electronic apparatus of claim 1, wherein the instructions, when executed by the at least one processor individually or collectively, further cause the electronic apparatus to, based on identifying that the stain is not removed based on output data acquired from the trained second neural network model, identify the stain identified in the first area as a pattern.

6. The electronic apparatus of claim 1, wherein the instructions, when executed by the at least one processor individually or collectively, further cause the electronic apparatus to, based on identifying that the stain is removed:
change the second cleaning mode to the first cleaning mode; and
travel in the travel space.

7. The electronic apparatus of claim 1, further comprising:
a driver,
wherein the instructions, when executed by the at least one processor individually or collectively, further cause the electronic apparatus to:
perform cleaning of the stain by traveling in the first area;
based on completion of the performing the cleaning of the stain, control the driver such that an image-capturing direction of the camera sensor faces the first area; and
based on acquiring the second image, control the driver such that the electronic apparatus travels along a travel path.

8. The electronic apparatus of claim 1, wherein the instructions, when executed by the at least one processor individually or collectively, further cause the electronic apparatus to:
perform cleaning of the stain by traveling in the first area;
based on completion of performing the cleaning of the stain, change the second cleaning mode to the first cleaning mode and travel in the travel space;
identify whether the electronic apparatus is within a pre-set distance from the first area while the electronic apparatus changes the second cleaning mode to the first cleaning mode and travels in the travel space;
based on identifying that the electronic apparatus is within the pre-set distance from the first area, acquire a fourth image of the first area through the camera sensor; and
identify whether the stain is removed by inputting, to the trained second neural network model, the acquired first image and the acquired fourth image.

9. The electronic apparatus of claim 1, further comprising:
a washer,
wherein the instructions, when executed by the at least one processor individually or collectively, further cause the electronic apparatus to:
acquire context information on the travel space based on at least one of sensing data acquired through the camera sensor or map information on the travel space; and
based on identifying that washing of the washer is required based on the context information, provide guide information indicating that washing is required.

10. The electronic apparatus of claim 1, further comprising:
a washer; and
a first sensor for sensing a contamination level of the washer,
wherein the instructions, when executed by the at least one processor individually or collectively, further cause the electronic apparatus to:
based on identifying that the contamination level of the washer is greater than or equal to a pre-set value based on sensing data acquired through the first sensor, provide guide information indicating washing of the washer is required, or travel to a docking station.

11. A method of operating an electronic apparatus, the method comprising:
acquiring information on one or more stains in a travel space by inputting, to a trained first neural network model, a first image acquired through a camera sensor of the electronic apparatus, wherein the first image is acquired while the electronic apparatus travels in the travel space in a first cleaning mode;
based on identifying a stain in a first area of the travel space, among the one or more stains, based on the acquired information, performing cleaning of the first area by changing the first cleaning mode to a second cleaning mode;
based on completion of the performing the cleaning of the first area, acquiring a second image of the first area through the camera sensor; and
identifying whether the stain is removed by inputting, to a trained second neural network model, the acquired first image and the acquired second image.

12. The method of claim 11, wherein the trained first neural network model is trained to, based on inputting an image of the first area, identify whether a stain is present in the first area, and
wherein the trained second neural network model is trained to, based on inputting input images comprising an image obtained before performing the cleaning of the first area and an image obtained after performing the cleaning of the first area, identify whether a stain previously identified in the first area has been removed by comparing the input images.

13. The method of claim 11, further comprising:
identifying the stain in the first area based on output data acquired from the trained first neural network model and cleaning history information,
wherein the cleaning history information comprises information on an area of the travel space in which cleaning was previously performed.

14. The method of claim 11, further comprising:
based on identifying that at least part of the stain remains based on output data acquired from the trained second neural network model, re-performing cleaning of the first area;
based on completion of the re-performing the cleaning of the first area, acquiring a third image of the first area through the camera sensor; and
re-identifying whether the stain is removed by inputting, to the trained second neural network model, the acquired second image and the acquired third image.

15. The method of claim 11, further comprising:
based on identifying that the stain is not removed based on output data acquired from the trained second neural network model, identify the stain identified in the first area as a pattern.

16. A non-transitory computer readable storage medium having instructions stored therein, which when executed by at least one processor of an electronic apparatus individually or collectively, cause the electronic apparatus to:
acquire information on one or more stains in a travel space by inputting, to a trained first neural network model, a first image acquired through a camera sensor of the electronic apparatus, wherein the first image is acquired while the electronic apparatus travels in the travel space in a first cleaning mode;
based on identifying a stain in a first area of the travel space, among the one or more stains, based on the acquired information, perform cleaning of the first area by changing the first cleaning mode to a second cleaning mode;
based on completing the cleaning of the first area, acquire a second image of the first area through the camera sensor; and
identify whether the stain is removed by inputting, to a trained second neural network model, the acquired first image and the acquired second image.

17. The non-transitory computer readable storage medium of claim 16, wherein the trained first neural network model is a model trained to, based on inputting an image of the first area, identify whether a stain is present in the first area, and
wherein the trained second neural network model is a model trained to, based on inputting input images comprising an image obtained before performing the cleaning of the first area and an image obtained after performing the cleaning of the first area, identify whether a stain previously identified in the first area has been removed by comparing the input images.

18. The non-transitory computer readable storage medium of claim 16, wherein the instructions, when executed by the at least one processor individually or collectively, further cause the electronic apparatus to identify the stain in the first area based on output data acquired from the trained first neural network model and cleaning history information, and
wherein the cleaning history information comprises information on an area of the travel space in which cleaning was previously performed.

19. The non-transitory computer readable storage medium of claim 16, wherein the instructions, when executed by the at least one processor individually or collectively, further cause the electronic apparatus to:
based on identifying that at least part of the stain remains based on output data acquired from the trained second neural network model, re-perform cleaning of the first area;
based on completion of the re-performing the cleaning of the first area, acquire a third image of the first area through the camera sensor; and
re-identify whether the stain is removed by inputting, to the trained second neural network model, the acquired second image and the acquired third image.

20. The non-transitory computer readable storage medium of claim 16, wherein the instructions, when executed by the at least one processor individually or collectively, further cause the electronic apparatus to, based on identifying that the stain is not removed based on output data acquired from the trained second neural network model, identify the stain identified in the first area as a pattern.
